(19) United States
(12) Patent Application Publication
(10) Pub. No.: US 2026/0254357 A1
(43) Pub. Date: Aug. 27, 2026

(54) MICROCONTROLLER AND METHOD FOR CONTROLLING A CONVERTER

(71) Applicant: STMicroelectronics International N.V., Geneva (CH)

(72) Inventors: Vincent ONDE, Fuveau (FR); Jean-Francois LINK, Trets (FR)

(73) Assignee: STMicroelectronics International N.V., Geneva (CH)

(21) Appl. No.: 19/536,661

(22) Filed: Feb. 11, 2026

(30) Foreign Application Priority Data
Feb. 26, 2025 (FR) FR 2501940

(51) Int. Cl. H02M 3/158; H02M 1/08; H02M 3/156; H02M 3/335; H02M 7/487

(52) U.S. Cl. CPC H02M 3/158; H02M 1/08; H02M 3/156; H02M 3/33507; H02M 7/487

(57) ABSTRACT

According to one aspect, a microcontroller is proposed including a control circuit of a three-level converter. The converter includes at least one phase branch including an upper transistor, an upper intermediate transistor, a lower intermediate transistor and a lower transistor disposed in series between two terminals of a power source. The control circuit includes a shutdown management circuit configured to keep in a conducting state the upper intermediate transistor and the lower intermediate transistor before making them non-conducting when an event requiring shutdown of the converter occurs.

### BACKGROUND

### Technical Field

Embodiments and implementations relate to converters.

### Description of the Related Art

A converter is a power electronic device that converts a voltage, in particular a direct voltage into another direct voltage or a direct voltage into an alternating voltage.

Two-level converters configured to generate two voltage levels, in particular a positive voltage and a zero voltage, or a positive voltage level and a negative voltage level, are known.

There are also three-level converters. These converters are configured to generate an intermediate level, particularly a neutral point, between a positive voltage level and a negative voltage level, or between a positive voltage level and a zero voltage. Three-level converters make it possible to improve the quality of the sinusoidal shape of the generated signal and reduce the harmonic distortion in the generated signal.

For example, three-level converters include “NPC” (Neutral Point Clamped) and “ANPC” (Active Neutral Point Clamped) converters.

A three-level converter may have a plurality of phase branches in order to generate a plurality of phases of an output signal. For example, a three-level converter may have three phase branches.

An “NPC” converter is a converter including two capacitors configured to divide a direct voltage V_{DC} into two equal parts in order to generate the three voltage levels: +V_{CC}/2, 0 (neutral point), -V_{CC/}2 or 0 Volt, V_{CC}/2 and V_{CC}. The “NPC” converter comprises four transistors for each phase branch. These transistors make it possible to control the voltage level as output of the phase branch. The “NPC” converter also includes two diodes (clamping diode) placed between the transistors and the neutral point.

An “ANPC” converter is a converter combining the advantages of an “NPC” diode converter with active switching to improve efficiency, reduce harmonic distortion, and better balance voltages. In particular, as opposed to “NPC” converters that use passive diodes, “ANPC” converters use active switches (usually “IGBT” or “MOSFET” transistors) instead of diodes.

For the “NPC” and “ANPC” converters, it is not possible to switch off all of the power transistors simultaneously to protect the converter, particularly to avoid damaging the transistors of the phase branches of the converter due to overvoltages.

### BRIEF SUMMARY

There is therefore a need to propose a solution for reducing the risk of damage to a three-level converter due to overvoltages.

According to one aspect, a microcontroller is proposed comprising a circuit for controlling a three-level converter, the converter including at least one phase branch comprising an upper transistor, an upper intermediate transistor, a lower intermediate transistor and a lower transistor disposed in series between two terminals of a power source, and wherein the control circuit includes a shutdown management circuit configured to, when an event requiring shutdown of the converter occurs, keep in a conducting state the upper intermediate transistor and the lower intermediate transistor before switching them into a non-conducting state.

Such a management circuit makes it possible to ensure that the upper intermediate transistor and the lower intermediate transistor switch into a non-conducting state after the upper transistor and the lower transistor of said at least one phase branch of the converter. Such a management circuit therefore makes it possible to carry out a protection sequence for avoiding a dangerous operating state for the converter. This makes it possible to limit, particularly to eliminate, the risk of damage to the converter due to overvoltages when the converter is shut down.

Such a management circuit is simple to implement and is inexpensive, particularly due to the integration thereof into a microcontroller.

Advantageously, the shutdown management circuit is configured to, when an event requiring shutdown of the converter occurs, keep in a conducting state the upper intermediate transistor and the lower intermediate transistor for a duration greater than a switching duration of the upper transistor and of the lower transistor.

Preferably, the control circuit also includes a control signal generation circuit configured to control transistors of a converter during normal operation of the converter, the shutdown management circuit being configured to, when an event requiring shutdown of the converter occurs, keep the control signals of the upper intermediate transistor and of the lower intermediate transistor to keep them conducting before making them non-conducting.

In an advantageous embodiment, the microcontroller further comprises a first signal generation circuit configured to generate a signal when an event requiring shutdown of the converter occurs, the control circuit being configured to receive this signal so that the shutdown management circuit keeps in the conducting state the upper intermediate transistor and the lower intermediate transistor when the control circuit receives the signal generated by this first signal generation circuit.

Advantageously, the microcontroller further comprises at least one register configured to store at least a delay defining a duration for keeping in the conducting state the upper intermediate transistor and the lower intermediate transistor for the shutdown management circuit.

Preferably, the control circuit further comprises a second signal generation circuit configured to generate a signal to a central processing unit of the microcontroller after a duration of keeping in the conducting state the upper intermediate transistor and the lower intermediate transistor by the shutdown management circuit.

In an advantageous embodiment, the control circuit also comprises a deadtime generation circuit configured to generate a deadtime during which:

the upper transistor and the lower intermediate transistor are in a non-conducting state, after switching one of these two transistors into a non-conducting state and before placing in a conducting state the other of these two transistors, and/or

the lower transistor and the upper intermediate transistor are in a non-conducting state, after switching one of these two transistors into a non-conducting state and before placing the other of these two transistors in a conducting state.

Advantageously, the second signal generation circuit is configured to generate the second signal after at least one keeping duration and the duration of the deadtime.

Advantageously, the central processing unit is configured to authorize a rearming of the converter after having received the second signal and when the event requiring shutdown of the converter has ended.

Furthermore, the fact of rearming the converter after said at least one keeping duration and the duration of the deadtime makes it possible to rearm the converter with any of the configurations authorized conducting the transistors of the converter without risk of deadtime violation.

Preferably, the microcontroller further comprises a counter configured to perform counting cycles, said counter being used for a pulse width modulation of the control signals of the transistors of the converter. Advantageously, the control circuit is configured to rearm the converter at the beginning of a new counting cycle of the counter. This makes it possible to have non-truncated pulse width modulation cycles, and therefore a good duty cycle, from the start of the transition to normal operating mode.

Alternatively, the control circuit is configured to rearm the converter as soon as the central processing unit has authorized the rearming of the converter.

Advantageously, when the upper transistor or when the lower transistor is conducting when an event requiring shutdown of the converter occurs, the control circuit is configured to keep this upper transistor or this lower transistor conducting for a first delay. Furthermore, when the upper intermediate transistor or when the lower intermediate transistor is conducting when an event requiring shutdown of the converter occurs, the control circuit is configured to keep this upper intermediate transistor or this lower intermediate transistor conducting for a second delay greater than the first delay.

According to another aspect, a method is proposed for controlling a three-level converter, the converter including at least one phase branch comprising an upper transistor, an upper intermediate transistor, a lower intermediate transistor and a lower transistor disposed in series between two terminals of a power source, the method comprising, when an event requiring shutdown of the converter occurs, keeping in a conducting state the upper intermediate transistor and the lower intermediate transistor before switching them to a non-conducting state.

### BRIEF DESCRIPTION OF THE SEVERAL VIEWS OF THE DRAWINGS

Other advantages and features of the various embodiments of the present disclosure will become apparent upon examining the detailed description of non-limiting embodiments, and from the appended drawings wherein:

FIG. 1 illustrates one embodiment of an electronic system comprising a microcontroller, a three-level converter, and a signal generation circuit according to an embodiment disclosed herein;

FIG. 2 illustrates a Neutral Point Clamped type converter according to an embodiment disclosed herein;

FIG. 3 illustrates an Active Neutral Point Clamped type converter according to an embodiment disclosed herein; and

FIG. 4 illustrates illustrates a time chart of an implementation of a method for controlling a three-level converter according to an embodiment disclosed herein.

### DETAILED DESCRIPTION

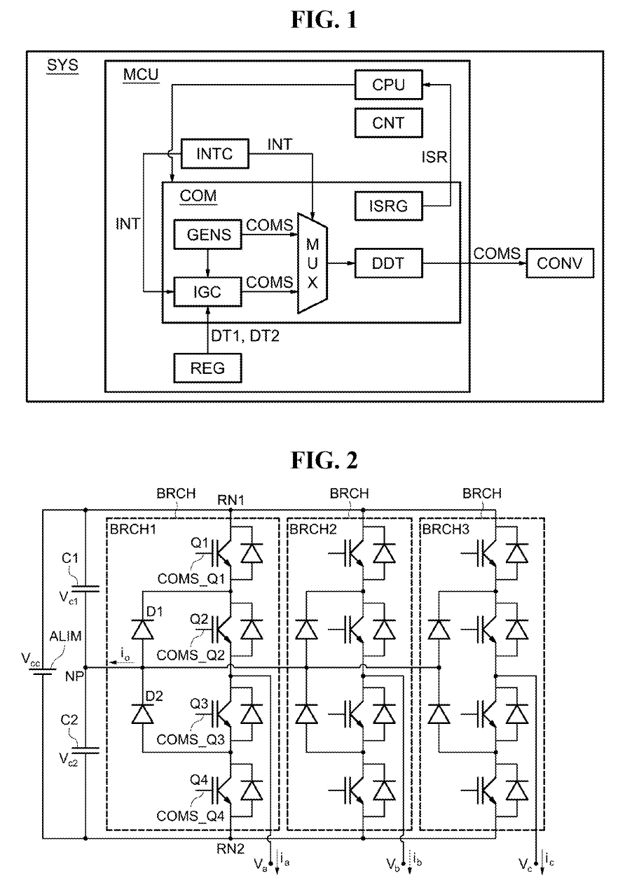

FIG. 1 schematically illustrates one embodiment of an electronic system SYS comprising a microcontroller MCU, a three-level converter CONV and a signal generation circuit INTC.

The converter CONV may be used to power a load, for example an electric motor. The converter CONV may for example be an inverter.

The three-level converter CONV may be an “NPC” (Neutral Point Clamped) or an “ANPC” (Active Neutral Point Clamped) converter.

For example, FIG. 2 schematically illustrates an “NPC” type converter CONV. An “NPC” type converter CONV is powered by a voltage VCC and comprises two capacitive elements C1 and C2 mounted in series, so that the equivalent capacitance of the capacitive elements C1 and C2 is in parallel with the voltage source VCC. These two capacitive elements C1, C2 make it possible to generate a voltage +Vcc/2 and a voltage -Vcc/2. A neutral point NP is defined between these two capacitive elements C1, C2.

The “NPC” type converter CONV is three-phase and comprises one branch BRCH for each phase. Each branch BRCH extends between a first reference node RN1 and a second reference node RN2. The first reference node RN1 is configured to receive a voltage +Vcc and the second reference node RN2 is configured to receive a 0 Volt voltage.

Each branch BRCH has a half bridge switching configuration. In particular, each branch BRCH comprises four transistors Q1, Q2, Q3 and Q4 in series between the first reference node RN1 and the second reference node RN2. In particular, each branch BRCH comprises an upper transistor Q1, an upper intermediate transistor Q2, a lower intermediate transistor Q3 and a lower transistor Q4.

The transistors Q1, Q2, Q3, Q4 of each branch may be insulated-gate bipolar type transistors (also referred to by the abbreviation “IGBT”).

Each branch of the “NPC” converter also comprises two diodes D1, D2. These two diodes D1, D2 are placed between the transistors Q1, Q2, Q3, Q4 and the neutral point NP. For example, as shown in FIG. 2, the cathode of diode D1 is connected to a neutral point NP between the upper transistor Q1 and the upper intermediate transistor Q2, and the anode of diode D2 is connected to a neutral point NP between the lower intermediate transistor Q3 and the lower transistor Q4.

Each branch BRCH has an output (O1, O2, O3) configured to transmit a phase of a signal (voltages Vₐ, V_{b}, V_{c} and signals iₐ, i_{b}, i_{c} ). This output is located between the upper intermediate transistor Q2 and the lower intermediate transistor Q3.

To generate a level voltage +V_{cc}at the output of a phase branch BRCH, the upper transistor Q1 and the upper intermediate transistor Q2 should be made conducting, and the lower intermediate transistor Q3 and the lower transistor Q4 should be made non-conducting.

To generate a level voltage +Vcc/2 Volt at the output of a phase branch BRCH, the upper intermediate transistor Q2 should be made conducting when the current at the output of the phase branch (iₐ, i_{b}, i_{c}) is output to the load, and the lower intermediate transistor Q3 when the current at the output of the phase branch (iₐ, i_{b}, i_{c}) is input from the load, and making the upper transistor Q1 and the lower transistor Q4 non-conducting.

To generate a 0 Volt level voltage at the output of a phase BRCH branch, the lower intermediate transistor Q3 and the lower transistor Q4 is made conducting, and the upper transistor Q1 and the upper intermediate transistor Q2 is made non-conducting.

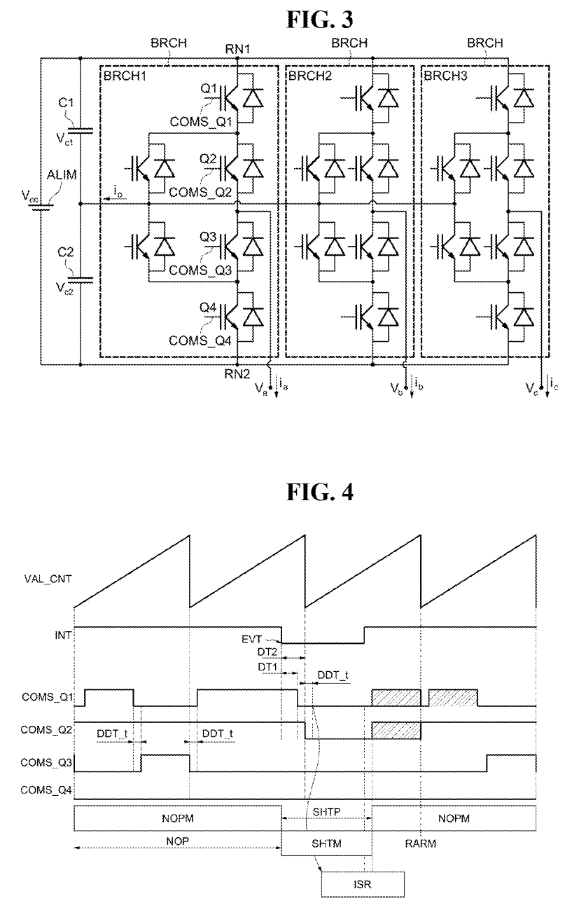

FIG. 3 schematically illustrates an “ANPC” type converter CONV. The “ANPC” type converter differs from the “NPC” type converter in that it comprises active switches CM1, CM2 (usually “IGBT” or “MOSFET” transistors) instead of diodes D1, D2.

Returning to FIG. 1, the MCU microcontroller includes a control circuit COM configured to control the transistors Q1, Q2, Q3 and Q4 of the three-level converter CONV.

The converter CONV may be controlled in a normal operating mode or in a shutdown management mode.

In the normal operating mode, the control circuit is configured to generate control signals COMS of the transistors Q1, Q2, Q3, Q4. These control signals have a sequence of pulses for alternating between high state and low state, in order to make the transistors Q1, Q2, Q3 and Q4 conducting or non-conducting. In particular, these control signals COMS are pulse width modulation signals (also referred to by the abbreviation “PWM”). These signals are generated in order to perform transitions between the voltages +V_{cc,} +V_{cc}/2, 0 Volt as output of the phase branch.

The shutdown management mode is used when an event requiring shutdown of the converter occurs. Such a shutdown event may be detected by a voltage sensor or a current sensor or a temperature sensor included in the electronic system.

For example, shutdown of the converter CONV may occur in case of overvoltage, overcurrent, or too high temperature, particularly in the motor powered by the converter. Shutdown of the converter CONV may also occur in case of a desaturation of the transistors of the converter, particularly when too high a current causes a change from a saturated mode to a linear mode.

In particular, the electronic system SYS also comprises a first control signal generation circuit INTC. The circuit INTC is configured to generate a signal INT for indicating that shutdown of the converter CONV should occur or is necessary. For example, the INTC circuit may be configured to generate a signal INT when an event requiring shutdown of the converter is detected.

The microcontroller is configured to shut down the converter CONV when a signal INT is generated by the circuit INTC.

Once shut down, the converter CONV may be rearmed, particularly when the event requiring shutdown of the converter CONV has ended. The rearming of the converter CONV corresponds to a reset of the converter CONV to return the converter CONV to an operating state.

In the normal operating mode, the control circuit COM is configured to control the converter according to a desired voltage level as output of each phase branch. The output voltage level of each phase branch BRCH depends on the control applied to the transistors Q1, Q2, Q3, Q4 of this branch. The control applied to a transistor makes it possible to make this transistor conducting or non-conducting.

A phase branch BRCH of the converter CONV operates safely when:

all of the transistors Q1, Q2, Q3 and Q4 of this branch are non-conducting,

the upper intermediate transistor Q2 is conducting and the other transistors Q1, Q3 and Q4 of this branch are non-conducting,

the lower intermediate transistor Q3 is conducting and the other transistors Q1, Q2 and Q4 of this branch are non-conducting,

the upper intermediate transistor Q2 and the lower intermediate transistor Q3 are conducting and the upper transistor Q1 and the lower transistor Q4 are non-conducting,

the upper transistor Q1 and the upper intermediate transistor Q2 are conducting and the lower intermediate transistor Q3 and the lower transistor Q4 are non-conducting,

the upper transistor Q1 and the upper intermediate transistor Q2 are non-conducting and the lower intermediate transistor Q3 and the lower transistor Q4 are conducting.

Other possible configurations of the phase branch of the converter should be avoided.

In particular, when the converter CONV is shut down, it should be avoided that the upper intermediate transistor Q2 and the lower intermediate transistor Q3 switch to a non-conducting state before the upper transistor Q1 and the lower transistor Q4.

Thus, in the shutdown management mode, the control circuit COM is configured to control the converter CONV to avoid making the upper intermediate transistor Q2 and the lower intermediate transistor Q3 non-conducting at the same time as the upper transistor Q1 and the lower transistor Q4, in order to prevent the converter CONV from being in an abnormal state. To do this, the control circuit COM is configured to make the transistors Q1, Q2, Q3 and Q4 of the converter CONV non-conducting according to a specific protection sequence when an event requiring shutdown of the converter CONV occurs.

More particularly, the control circuit COM comprises a circuit GENS generating normal operation control signals .

This generator circuit GENS is configured to generate control signals COMS adapted to control the transistors Q1, Q2, Q3 and Q4 when the converter CONV operates normally. The control signals COMS are particularly pulse width modulation signals.

A counter CNT is used for pulse width modulation. This counter CNT is configured to increment a value from an initial value to a maximum value at a defined frequency. Once the maximum value is reached, the counter value is reset to the initial value thereof in order to start a new increment cycle. The cycle of the counter defines the “PWM” cycle of the control signals COMS.

The control circuit COM also includes a shutdown management circuit IGC. The shutdown management circuit IGC is configured to control the converter CONV at three levels when an interruption INT is generated by the control generation circuit INTC, that is to say when shutdown of the converter CONV should occur or is necessary.

In particular, the shutdown management circuit IGC is configured to delay making the upper intermediate transistor Q2 and the lower intermediate transistor Q3 non-conducting so that it occurs after the upper transistor Q1 and the lower transistor Q4 are made non-conducting.

In particular, the shutdown management circuit IGC is configured to keep the state of the control signals COMS of the upper intermediate transistor Q2 and of the lower intermediate transistor Q3 when these transistors Q2 and Q3 are conducting at the time when an event requiring shutdown of the converter CONV occurs.

More particularly, the shutdown management circuit IGC may comprise a first input configured to receive the control signals COMS of the transistors Q1, Q2, Q3 and Q4 (or Q2 and Q3) of the converter CONV in order to know the state of each control signal COMS (COMS_Q1, COMS_Q2, COMS_Q3 and COMS_Q4). The shutdown management circuit IGC may also comprise a second input configured to receive the control signal INT.

The control circuit is configured to keep the upper transistor Q1 or the lower transistor Q4 conducting for a delay DT1 when an event requiring shutdown of the converter occurs when this upper transistor Q1 or this lower transistor Q4 is conducting.

The control circuit is also configured to keep the upper intermediate transistor Q2 or the lower intermediate transistor Q3 conducting for a delay DT2 when an event requiring shutdown of the converter occurs when this upper intermediate transistor Q2 or this lower intermediate transistor Q3 is conducting.

In particular, the shutdown management circuit IGC may comprise at least one counter configured to count the delay DT1 during which the upper transistor Q1 and the lower transistor Q4 may be kept conducting from a detection of an event requiring shutdown of the converter. Said at least one counter is configured to count the delay DT2 during which the upper intermediate transistor Q2 and the lower intermediate transistor Q3 may be kept conducting from a detection of an event requiring shutdown of the converter. The delay DT2 is greater than the delay DT1.

Such a shutdown management circuit IGC makes it possible to ensure that the upper intermediate transistor Q2 and the lower intermediate transistor Q3 switch into a non-conducting state after the upper transistor Q1 and the lower transistor Q4. Such a shutdown management circuit IGC therefore makes it possible to carry out a protection sequence making it possible to avoid a dangerous operating state for the converter. This makes it possible to limit, particularly to eliminate, a risk of damage to the converter due to overvoltages when shutting down the converter CONV.

Such a management circuit is simple to implement and is inexpensive, particularly due to the integration thereof into a microcontroller.

The control circuit COM may also comprise a multiplexer MUX configured to select the control signals COMS as output of the normal operation control signal generation circuit GENS or the control signals COMS as output of the shutdown management circuit IGC depending on whether or not a control signal INT has been generated by the control generation circuit INTC.

In particular, the multiplexer MUX has a first input configured to receive the control signals COMS generated by the control signal generation circuit GENS.

The multiplexer MUX has a second input configured to receive the control signals COMS generated by the shutdown management circuit IGC.

The multiplexer MUX also has a selection input configured to receive a control signal INT for indicating which control signals COMS to use to control the transistors of the converter.

The control circuit COM also comprises a deadtime DDT generation circuit. This circuit DDT is configured to generate a deadtime DDT_t on the control signals COMS during which no transistor on the upper part of the same branch or on the lower part of the same branch is conducting, in order to avoid a direct short-circuit through the power transistors of the same phase.

The microcontroller MCU includes at least one register REG configured to store said at least one delay DT1, DT2 to be applied to delay shutdown of the upper intermediate transistor Q2 and of the lower intermediate transistor Q3 when an event requiring shutdown of the converter occurs. Said at least one stored delay is thus used to configure the shutdown management circuit IGC.

Said at least one delay to be applied is chosen so as to be greater than a switching time of the upper transistor Q1 and of the lower transistor Q4. Said at least one delay to be applied is also chosen so as to limit, particularly to eliminate, converter a risk of damage to the transistors of the phase branches of the converter. For example, said at least one delay is chosen to be between 1 and 3 microseconds.

As seen previously, a first delay DT1 is defined to delay making the upper transistor Q1 non-conducting, when an event requiring shutdown of the converter occurs. A second delay DT2 is defined to delay making the upper intermediate transistor Q2 non-conducting in relation to making the upper transistor Q1 non-conducting, when an event requiring shutdown of the converter occurs. These two delays make it possible to make the upper intermediate transistor Q2 non-conducting after the upper transistor Q1. The first delay DT1 may be zero. The second delay DT2 is greater than the first delay DT2.

Furthermore, the first delay DT1 is also defined to delay making the lower transistor Q4 non-conducting, when an event requiring shutdown of the converter occurs. A second delay DT2 is defined to delay making the lower intermediate transistor Q3 non-conducting in relation to making the lower transistor Q4 non-conducting, when an event requiring shutdown of the converter occurs. These two delays make it possible to make the lower intermediate transistor Q3 non-conducting after the upper transistor Q4.

The delay DT2 makes it possible to differentiate the shutdown time of the upper transistor Q1 and of the lower transistor Q4 in relation to the shutdown time of the upper intermediate transistor Q2 and the shutdown transistor of the lower intermediate transistor Q3.

The microcontroller also comprises a second protection sequence end signal generation circuit ISRG configured to generate a signal ISR when said at least one delay DT1, DT2 has ended and after the deadtime DDT_t generated by the protection generation circuit.

The circuit ISRG is configured to transmit the signal ISR to a central processing unit CPU of the microcontroller MCU.

The central processing unit CPU is configured to rearm the converter CONV once the event requiring shutdown of the converter CONV has ended after receiving the signal ISR.

Advantageously, the rearming of the converter CONV may be performed synchronously with the cycles of the counter CNT used for the pulse width modulation. In particular, the control circuit may comprise a circuit for waiting for a new cycle of the counter CNT to rearm the converter CONV. Rearming may be performed by resetting the multiplexer MUX. This makes it possible to have non-truncated pulse width modulation cycles, and therefore a good duty cycle, from the start of the transition to normal operating mode.

Alternatively, it is possible to have a control circuit COM configured to rearm the converter CONV without waiting for a new cycle of the counter CNT, as soon as the central processing unit CPU authorises the rearming of the converter CONV.

FIG. 4 illustrates a time chart of an implementation of a method for controlling a three-level converter CONV.

The signal INT corresponds to the signal INT that may be generated by the signal generation circuit INTC. The signal INT may be configured to be in a high state when no event requiring shutdown of the converter CONV is detected, and in a low state when such an event is detected. Alternatively, the signal INT may be configured to be in a low state when no event requiring shutdown of the converter CONV is detected, and in a high state when such an event is detected.

The signal COMS_Q1 corresponds to the control signal COMS controlling the upper transistor Q1.

The signal COMS_Q2 corresponds to the control signal COMS controlling the upper intermediate transistor Q2.

The signal COMS_Q3 corresponds to the control signal COMS controlling the lower intermediate transistor Q3.

The signal COMS_Q4 corresponds to the control signal COMS controlling the upper transistor Q4.

The signal VAL_CNT corresponds to the value of the counter CNT used for pulse width modulation.

FIG. 4 illustrates the control signals COMS_Q1, COMS_Q2, COMS_Q3, COMS_Q4 during a normal operating mode NOPM of the converter CONV, during a period NOP, then during a shutdown management mode SHTM, during a period SHTP, when an event requiring shutdown of the converter CONV is detected at a moment EVT.

In particular, the control signals COMS_Q1, COMS_Q2, COMS_Q3, COMS_Q4 during a normal operating mode switch from a high state to a low state, and vice versa, according to a pulse width modulation, according to the desired voltage level as output of the phase branch.

When the event occurs, this event is detected, for example, by a voltage or current or temperature sensor detecting a predefined threshold violation. For example, the signal INT changes from high to low.

In the illustrated implementation, when the event requiring shutdown of the converter CONV occurs, the control signals COMS_Q1, COMS_Q2 of the upper transistor Q1 and the upper intermediate transistor Q2 are in the high state, and the control signals COMS_Q3 and COMS_Q4 of the lower intermediate transistor Q3 and of the lower transistor Q4 are in the low state. Nevertheless, an event requiring shutdown of the converter may also occur in any of the other authorized configurations (particularly when the control signals COMS_Q2 and COMS_Q3 are in the high state and the control signals COMS_Q1 and COMS_Q4 are in the low state, or when the control signals COMS_Q1 and COMS_Q2 are in the low state and the control signals COMS_Q3 and COMS_Q4 are in the high state).

When the event requiring shutdown of the converter CONV occurs, the upper transistor Q1 is kept conducting for a delay DT1, and the upper intermediate transistor Q2 is kept conducting for a delay DT2.

Once the delay DT2 has ended and the deadtime DDT_t has passed, an end of protection sequence signal ISR is sent to the central processing unit CPU of the microcontroller MCU in order to indicate that the converter is shut down.

Once the event requiring shutdown of the converter CONV has ended, a reset of the converter CONV is performed, at the moment RARM, at the beginning of a new cycle of the counter CNT used for pulse width modulation. Rearming makes it possible for the converter CONV to be controlled again according to a normal operating mode NOPM.

The transmission of the signal ISR once the delay DT2 has ended and the deadtime DDT_t has passed makes it possible to prevent the central processing unit CPU from monitoring the state of the converter between the detection of the event requiring shutdown of the converter and the end of the converter protection sequence, before rearming the converter.

In a variant of the illustrated implementation, the event requiring shutdown of the converter may occur when the lower intermediate transistor Q3 and the lower transistor Q4 are conducting (the signals COMS_Q3 and COMS_Q4 being in a high state), and the upper transistors Q1 and the upper intermediate transistor Q2 are non-conducting (the signals COMS_Q1 and COMS_Q2 being in a low state). In this case, the lower transistor Q4 is kept conducting for a delay DT1, and the lower intermediate transistor Q3 is kept conducting for a delay DT2.

In another variant of the illustrated implementation, the event requiring shutdown of the converter may occur when the upper intermediate transistor Q2 and the lower intermediate transistor Q3 are conducting (the signals COMS_Q2 and COMS_Q3 being in a high state), and the upper transistors Q1 and the lower transistor Q4 are non-conducting (the signals COMS_Q1 and COMS_Q4 being in a low state). In this case, the upper intermediate transistor Q2 and the lower intermediate transistor Q3 are kept conducting for a delay DT2.

Microcontroller is summarized as including a control circuit (COM) of a three-level converter (CONV), the converter (CONV) including at least one phase branch comprising an upper transistor (Q1), an upper intermediate transistor (Q2), a lower intermediate transistor (Q3) and a lower transistor (Q4) disposed in series between two terminals of a power source (VCC, -VCC), and wherein the control circuit (COM) includes a shutdown management circuit (IGC) configured to, when an event requiring shutdown of the converter (CONV) occurs, keep in a conducting state the upper intermediate transistor (Q2) and the lower intermediate transistor (Q3) before switching them into a non-conducting state.

The shutdown management circuit (IGC) is configured to, when an event requiring shutdown of the converter (CONV) occurs, keep in a conducting state the upper intermediate transistor (Q2) and the lower intermediate transistor (Q3) for a duration greater than a switching duration of the upper transistor (Q1) and of the lower transistor (Q4).

The control circuit (COM) also includes a control signal generation circuit (GENS) configured to control transistors (Q1, Q2, Q3, Q4) of a converter (CONV) during normal operation of the converter (CONV), the shutdown management circuit (IGC) being configured to, when an event requiring shutdown of the converter (CONV) occurs, keep the control signals of the upper intermediate transistor (Q2) and of the lower intermediate transistor (Q3) to keep them conducting before making them non-conducting.

The microcontroller further includes a first signal generation circuit (INTC) configured to generate a signal (INT) when an event requiring shutdown of the converter occurs, the control circuit being configured to receive this signal (INT) so that the shutdown management circuit keeps in the conducting state the upper intermediate transistor (Q2) and the lower intermediate transistor when the control circuit receives the signal (INT) generated by this first signal generation circuit (INTC).

The microcontroller further includes at least one register configured to store at least one delay defining a duration of keeping in the conducting state the upper intermediate transistor and the lower intermediate transistor for the shutdown management circuit (IGC).

The control circuit further includes a second signal generation circuit (ISRG) configured to generate a second signal (ISR) to a central processing unit (CPU) of the microcontroller after a duration of keeping in the conducting state the upper intermediate transistor and the lower intermediate transistor by the shutdown management circuit.

The control circuit (COM) also includes a deadtime generation circuit (DDT) configured to generate a deadtime during which: the upper transistor (Q1) and the lower intermediate transistor (Q3) are in a non-conducting state, after switching one of these two transistors (Q1, Q3) into a non-conducting state and before placing the other of these two transistors (Q1, Q3) in a conducting state, and/or the lower transistor (Q4) and the upper intermediate transistor (Q2) are in a non-conducting state, after switching one of these two transistors (Q4, Q2) into a non-conducting state and before placing the other of these two transistors (Q4, Q2) in a conducting state.

The second signal generation circuit (ISRG) is configured to generate the second signal (ISR) after at least one keeping duration and the duration of the deadtime.

The central processing unit (CPU) is configured to authorize a rearming of the converter after having received the second signal (ISR) and when the event requiring shutdown of the converter has ended.

The microcontroller further includes a counter (CNT) configured to perform counting cycles, said counter being used for a pulse width modulation of the control signals (COMS) of the transistors of the converter, and wherein the control circuit (COM) is configured to rearm the converter at the beginning of a new counting cycle of the counter (CNT).

The control circuit (COM) is configured to rearm the converter (CONV) as soon as the central processing unit (CPU) has authorized the rearming of the converter.

When the upper transistor (Q1) or when the lower transistor (Q4) is conducting when an event requiring shutdown of the converter occurs, the control circuit (COM) is configured to keep this upper transistor (Q1) or this lower transistor (Q4) conducting for a first delay, and wherein, when the upper intermediate transistor or when the lower intermediate transistor is conducting when an event requiring shutdown of the converter occurs, the control circuit (COM) is configured to keep this upper intermediate transistor or this lower intermediate transistor conducting for a second delay greater than the first delay.

The three-level converter (CONV) is an “NPC” converter or an “ANPC” converter.

A method for controlling a three-level converter (CONV), the converter (CONV) including at least one phase branch including an upper transistor (Q1), an upper intermediate transistor (Q2), a lower intermediate transistor (Q3) and a lower transistor (Q4) disposed in series between two terminals of a power source (VCC, -VCC), is summarized as including, when an event requiring shutdown of the converter (CONV) occurs, keeping in a conducting state the upper intermediate transistor (Q2) and the lower intermediate transistor (Q3) before switching them into a non-conducting state.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A microcontroller comprising:
a control circuit of a three-level converter,
the converter including at least one phase branch including an upper transistor, an upper intermediate transistor, a lower intermediate transistor, and a lower transistor disposed in series between two terminals of a power source,
the control circuit including a shutdown management circuit configured to, in case a shutdown event of the converter occurs, keep the upper intermediate transistor and the lower intermediate transistor in conducting states before switching the upper intermediate transistor and the lower intermediate transistor into non-conducting states.

2. The microcontroller according to claim 1, wherein the shutdown management circuit is configured to, in case the shutdown event of the converter occurs, keep the upper intermediate transistor and the lower intermediate transistor in conducting states for a duration greater than a switching duration of the upper transistor and of the lower transistor.

3. The microcontroller according to claim 1, wherein the control circuit includes a control signal generation circuit configured to control the upper, upper intermediate, lower intermediate, and lower transistors during normal operation of the converter, the shutdown management circuit being configured to, in case the shutdown event of the converter occurs, control the upper intermediate transistor and the lower intermediate transistor to keep the upper intermediate transistor and the lower intermediate transistor in conducting states before switching the upper intermediate transistor and the lower intermediate transistor into non-conducting states.

4. The microcontroller according to claim 1, further comprising:
a first signal generation circuit configured to generate a first signal in case the shutdown event of the converter occurs, the control circuit being configured to receive the first signal generated by the first signal generation circuit so that the shutdown management circuit keeps the upper intermediate transistor and the lower intermediate transistor in conducting states in response to the control circuit receiving the first signal generated by the first signal generation circuit.

5. The microcontroller according to claim 1, further comprising:
at least one register configured to store at least one delay defining a duration of keeping in the upper intermediate transistor and the lower intermediate transistor in conducting states for the shutdown management circuit.

6. The microcontroller according to claim 4, wherein the control circuit includes a second signal generation circuit configured to generate a second signal for a central processing unit of the microcontroller after a duration of keeping in the upper intermediate transistor and the lower intermediate transistor in conducting states by the shutdown management circuit.

7. The microcontroller according to claim 1, wherein the control circuit includes a deadtime generation circuit configured to generate a deadtime during which:
the upper transistor and the lower intermediate transistor are in non-conducting states, after switching one of the upper transistor or the lower intermediate transistor into the non-conducting state and before placing the other of the upper transistor or the lower intermediate transistor in the conducting state, or
the lower transistor and the upper intermediate transistor are in non-conducting states, after switching one of the lower transistor or the upper intermediate transistor into the non-conducting state and before placing the other of the lower transistor or the upper intermediate transistor in the conducting state.

8. The microcontroller according to claim 6, wherein the second signal generation circuit is configured to generate the second signal after at least one keeping duration and the duration of the deadtime.

9. The microcontroller according to claim 6, wherein the central processing unit is configured to authorize a rearming of the converter after having received the second signal and in case the shutdown event of the converter has ended.

10. The microcontroller according to claim 9, further comprising:
a counter configured to perform counting cycles, the counter being used for a pulse width modulation of control signals of the upper, upper intermediate, lower intermediate, and lower transistors of the converter,
wherein the control circuit is configured to rearm the converter at a beginning of a new counting cycle of the counter.

11. The microcontroller according to claim 9, wherein the control circuit is configured to rearm the converter in response to the central processing unit authorizing the rearming of the converter.

12. The microcontroller according to claim 1, wherein, in case the upper transistor or the lower transistor is conducting when the shutdown event of the converter occurs, the control circuit is configured to keep the upper transistor or the lower transistor conducting for a first delay, and
wherein, in case the upper intermediate transistor or the lower intermediate transistor is conducting when the shutdown event of the converter occurs, the control circuit is configured to keep the upper intermediate transistor or the lower intermediate transistor conducting for a second delay greater than the first delay.

13. The microcontroller according to claim 1, wherein the three-level converter is a Neutral Point Clamped (NPC) converter or an Active Neutral Point Clamped (ANPC) converter.

14. A method for controlling a three-level converter including at least one phase branch having an upper transistor, an upper intermediate transistor, a lower intermediate transistor and a lower transistor disposed in series between two terminals of a power source, the method comprising:
in case a shutdown event of the converter occurs, keeping the upper intermediate transistor and the lower intermediate transistor in conducting states before switching the upper intermediate transistor and the lower intermediate transistor into non-conducting states.

15. The method according to claim 14, further comprising:
in case the shutdown event of the converter occurs, keeping the upper intermediate transistor and the lower intermediate transistor in conducting states for a duration greater than a switching duration of the upper transistor and of the lower transistor.

16. A device comprising:
a three-level converter including a first reference node, a second reference node, and a plurality of phase branches,
each of the plurality of phase branches including an upper transistor, an upper intermediate transistor, a lower intermediate transistor, and a lower transistor connected in series between the first reference node and the second reference node; and
a control circuit coupled to the three-level converter,
the control circuit configured to generate control signals to control the upper transistor, the upper intermediate transistor, the lower intermediate transistor, and the lower transistor,
in case a shutdown event of the converter occurs, the control circuit generates control signals to keep the upper intermediate transistor and the lower intermediate transistor in conducting states while switching the upper intermediate transistor and the lower intermediate transistor from conductive states into non-conducting states.

17. The device according to claim 16, wherein, in case the shutdown event of the converter occurs, the control circuit is configured to generate control signals to keep the upper intermediate transistor and the lower intermediate transistor in conducting states for a duration greater than a switching duration of the upper transistor and of the lower transistor.

18. The device according to claim 16, wherein the three-level converter is a Neutral Point Clamped (NPC) converter or an Active Neutral Point Clamped (ANPC) converter.

19. The device according to claim 16, further comprising:
a first signal generation circuit configured to provide a first signal indicating the shutdown event of the converter to the control circuit.

20. The device according to claim 16, further comprising:
a sensor configured to detect the shutdown event of the converter.
